(19) United States
(12) Patent Application Publication
(10) Pub. No.: US 2015/0296990 A1
(43) Pub. Date: Oct. 22, 2015

(54) Covered wheelchair

(71) Applicants: Bashir Malik, Los Angeles, CA (US); Rashad Khalil, Los Angeles, CA (US)

(72) Inventors: Bashir Malik, Los Angeles, CA (US); Rashad Khalil, Los Angeles, CA (US)

(21) Appl. No.: 13/987,370

(22) Filed: Jul. 12, 2013

(51) Int. Cl. A47C 7/66; A61G 5/10

(52) U.S. Cl. CPC A47C 7/66; A61G 5/10

(57) ABSTRACT

Product design has two applications, one for manual, another for motorized wheelchairs and has three parts: 1) An upper body hemispheric bubble/canopy. It is tented, transparent, and blocks ultra violet sun rays. Canopy is lifted by wheelchair's occupant or by electric motorized lifting/lowering mechanism and swings up from behind wheelchair to settle, umbrella-like, over occupant. 2) A lower body wrap-around plastic “curtain”. It is accordion-pleated and easily attaches by zipper to the upper body canopy. 3) An optional protection for anyone pushing the wheelchair. It is a canopy on a telescoping rod which is easily angled/adjusted as desired. It quickly attaches/detaches by clamp and screw. All products are lightweight and can be folded for ease of carry and accessibility.

The distinguishing feature of the motorized version is rechargeable battery operated push buttons next to the armrest and next to the footplate that can activate the canopy and wrap-around curtain.

### SUMMARY OF INVENTION

The present invention comprises conventional wheelchair mounted to a frame with a pair of spaced wheels for engaging a supportive surface to allow the wheelchair to be wheeled or pushed along the surface to another desired location when a moving force is exerted against the chair for moving it by means of the chair's wheels. The improved wheelchair includes a protective hood mounted to the frame of the chair. The protective hood is swing able between a shielding position that protects the individual seated in the chair and exposed to the elements such as rain or snow, wind or the like precipitation by activating a protective hood between a non-shielding to a shielding position as well as a storage position by a single control arm operable by an occupant of the wheelchair.

Although the prior art discloses various improvements to wheelchair for varying purposes, none have been provided improvements that protect both the wheelchair occupant and/or the individuals assigned to push the chair to move it to a new location. For the purposes of the present invention, this “pushing” individual is usually positioned behind the chair to exert a pushing force on the chair to propel it forward to a new desired location. The important feature of the present invention is the provision of means for shielding an individual seated in the wheelchair from exposure to the prevailing elements, such as wind, rain, snow by the provision of a hood-like shielding element normally arraigned above the individual seated in the chair to protect the individual rendering the invention to be more useful under all weather conditions. The improvements to the present wheelchair may be inexpensively incorporated rendering the invention to be more useful under all weather conditions. The improvements to the present wheelchair may be inexpensively incorporated with any present day wheelchair and without the need for skilled workers.

The resulting chair then provides, inexpensively, an improved wheelchair that is usable under all weather conditions, unlike as found in U.S. Pat. No. 6,209,611 granted on Apr. 3, 2001, U.S. Pat. No. 4,949,240 granted Aug. 21, 1990, U.S. Pat. No. 4,754,987 granted Jul. 5, 1988. For example, U.S. Pat. No. 4,754,987 discloses a wheelchair with a removable enclosure for inclement weather, U.S. Pat. No. 4,940,740 discloses a removable enclosure for inclement weather in the form of a protective hood for wheelchairs, while U.S. Pat. No. 6,209,611 discloses a collapsible cover for mounting to a wheelchair to protect against all the various weather conditions wind, rain, snow when the chair is used outdoor under these conditions.

This invention also protects the individual who is acting to move the chair from the rear and when outside is exposed to all prevailing conditions unlike prior art wheelchairs. The present invention discloses a protective hood mounted to the chair's frame that is swing able between a shielding position that protects the individuals seated in the chair and a non-shielding position as for a storage position, by means of a single control arm movable by the occupant of the wheelchair. The wheelchair is designed to permit the occupant to freely leave the wheelchair.

### Covered Wheelchair

### FIELD OF INVENTION

This invention discloses a covered wheelchair adapted to protect an individual in the wheelchair from all types of weather an individual seated in the chair may be exposed to when the chair is moved outdoors and is exposed to all the varying weather conditions. The improved wheelchair also includes means for protecting an individual that pushes the chair from the rear from all weather conditions while pushing the chair outdoors.

### BACKGROUND OF INVENTION

Most present day wheelchairs do not have any protection for an individual activating the wheelchair when it is occupied from al weather conditions and thereby leave the chair occupant exposed to all weather conditions when the chair is moved outside. This also exposes the individual who is acting to move the chair by pushing and moving the chair outside and exposing the chair occupant to all weather conditions such as wind, rain, snow or the like. The prior art discloses modified wheelchairs that are enclosed, with removable enclosures for limited purposes but non are none designed for protection from all varying weather conditions. This invention discloses a covered wheelchair that affords protection from all the different weather conditions. In addition to rain, snow, wind and the like that permits the chair to be useful under all weather condition to the chair occupant the present invention is designed to protect the individual who has been assigned to push the chair and move it to different locations under all weather conditions unlike prior art chairs.

### DESCRIPTION OF INVENTION

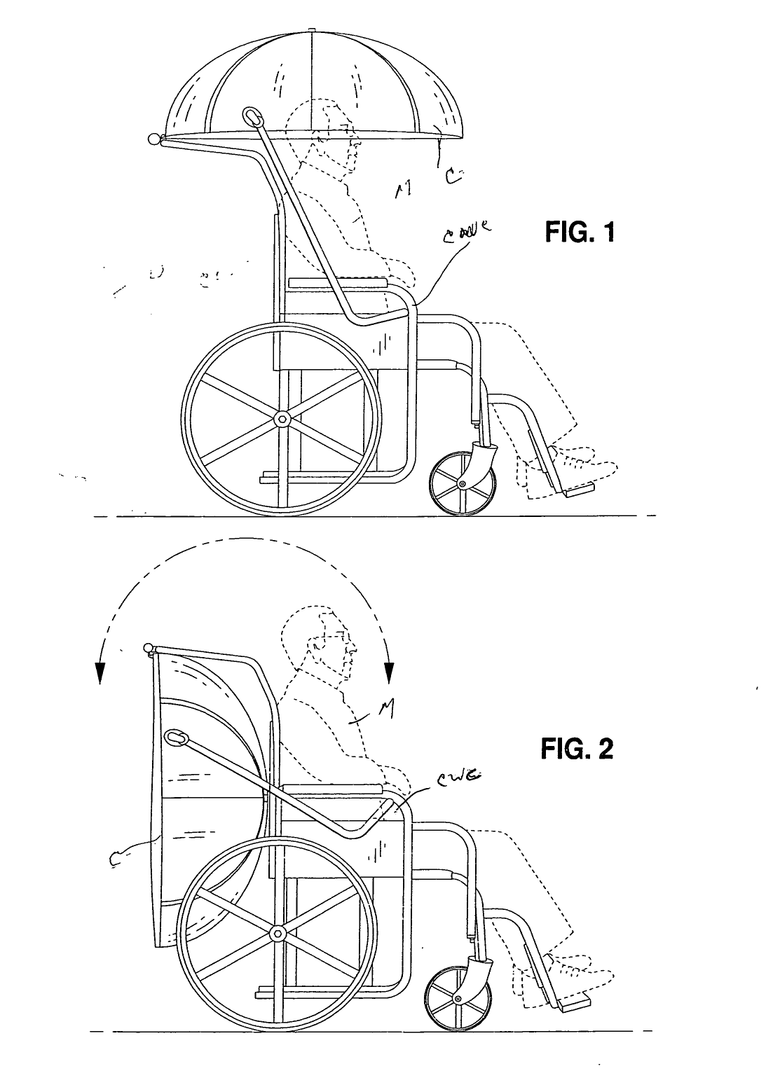

Now referring to the drawings and referring to FIG. 1 which illustrates a conventional wheelchair, CWC, with an individual seated on the wheelchair seat the individual M being illustrated in dotted outline and the wheelchair CWC illustrated with an umbrella-like cover C in an open condition over the chair occupant. The cover is secured to a control arm CA that moves the cover C between an open condition as illustrated in FIG. 4 and a closed position behind the chair shown in FIG. 2.

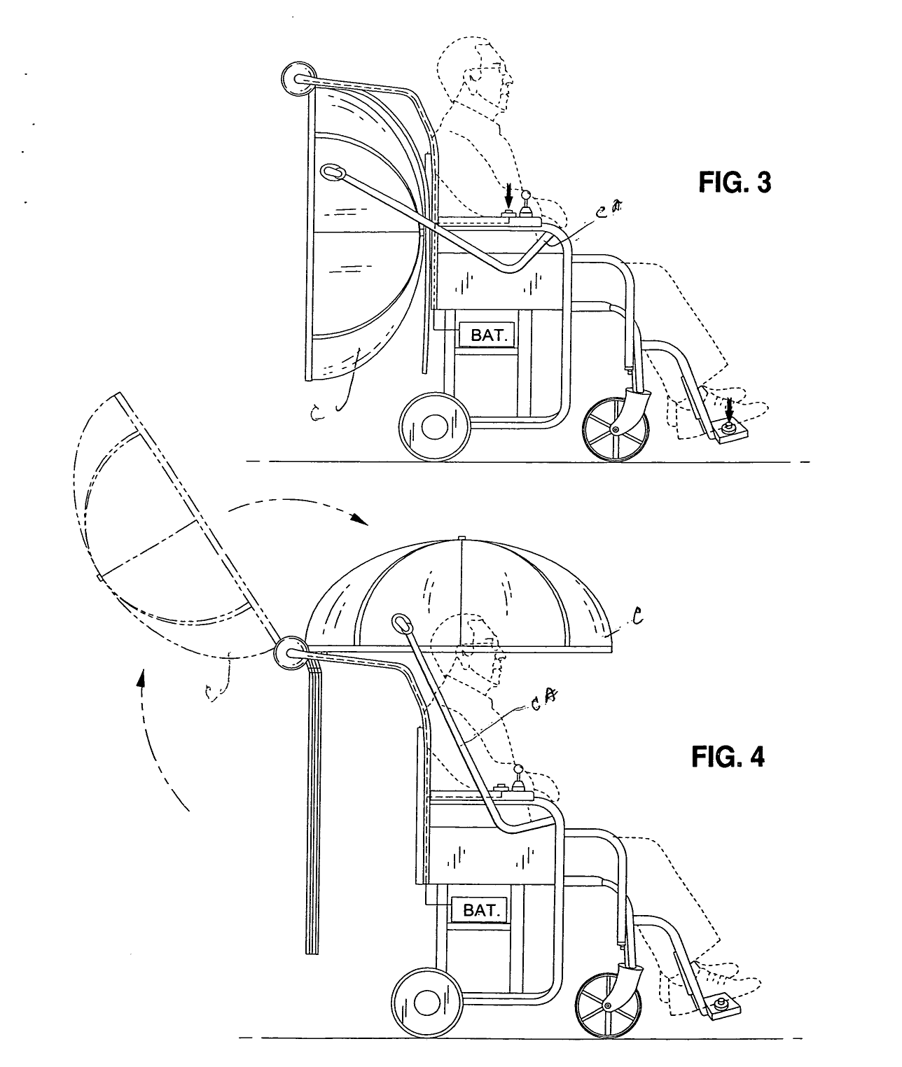

FIG. 3 illustrates the wheelchair of FIG. 1 with a battery power source BS and controlled by push buttons located on an arm of the wheelchair as is evident from examining FIGS. 3 and 4 or alternately the control buttons may be located on the arm of the wheelchair and/or footrest for the chair as is evident from FIGS. 3 and 4.

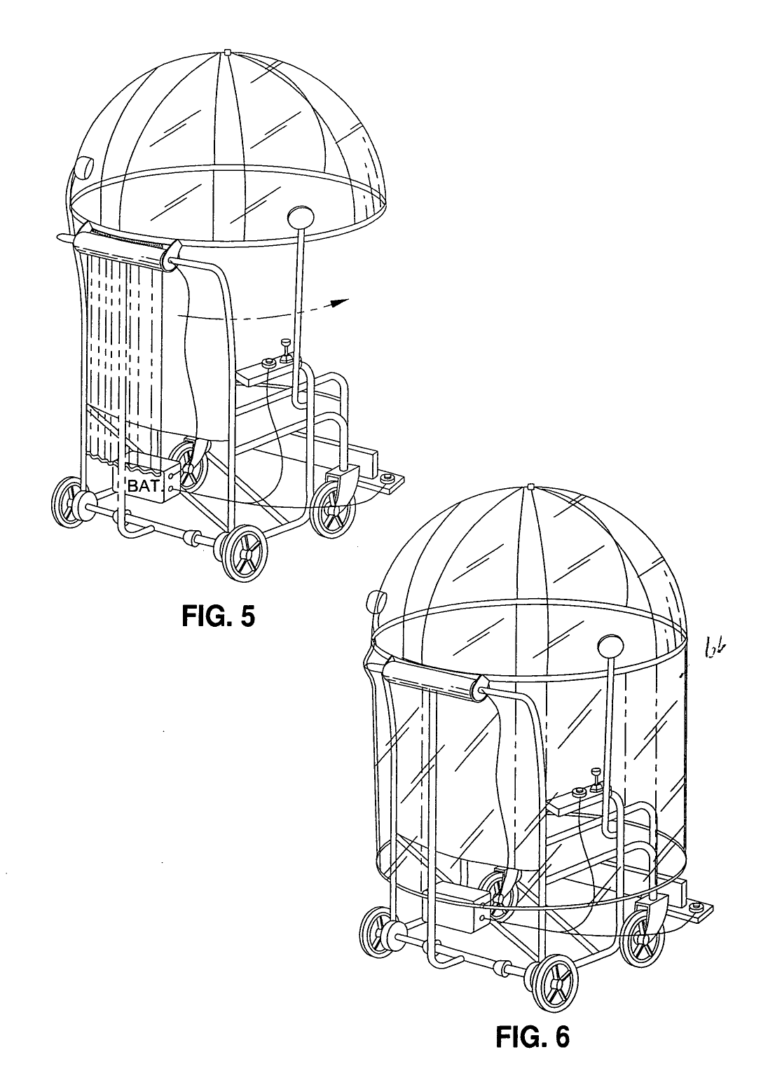

FIGS. 5, 6, and 7 illustrates the dome-like enclosure for enclosing the wheelchair from the environment and also function to isolate and individual that may be seated in the chair as is evident to one skilled in the art form viewing and examining these figures.

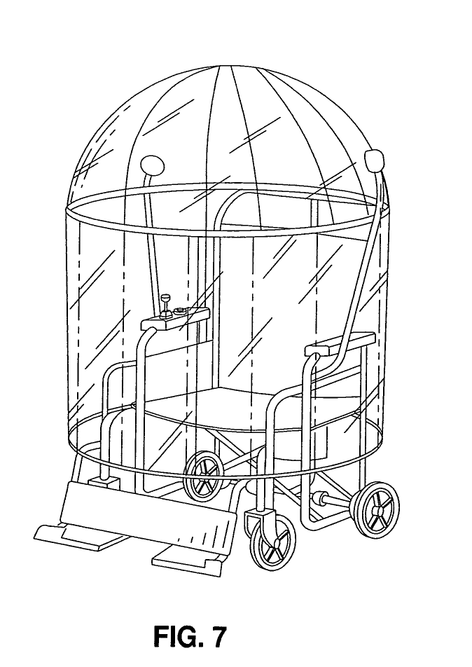

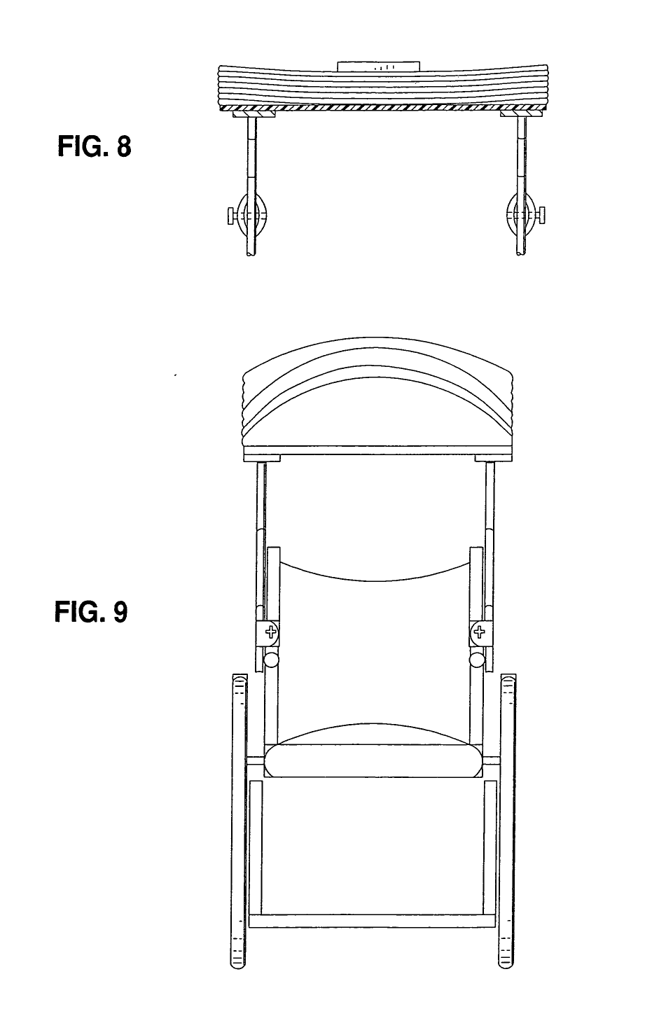

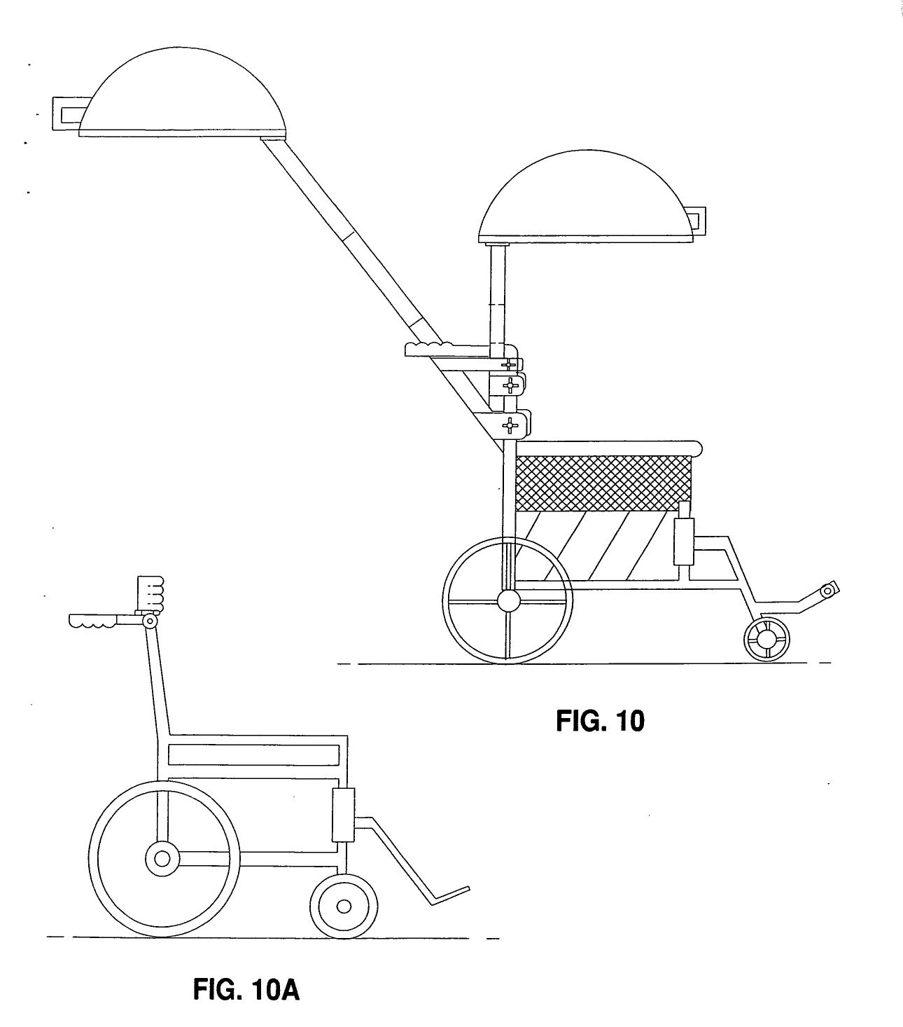

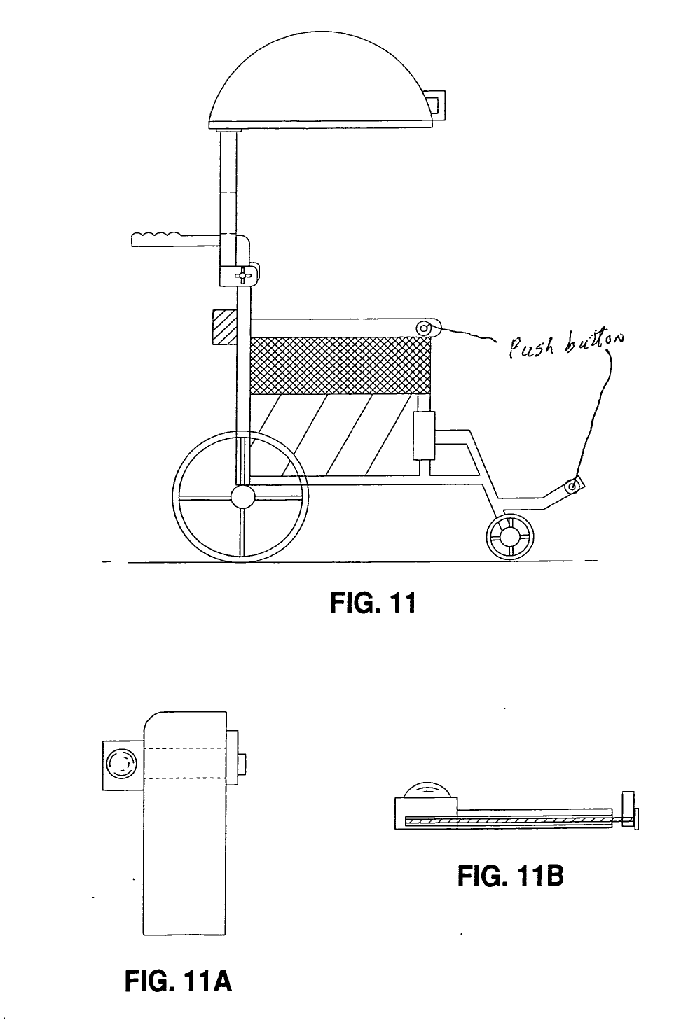

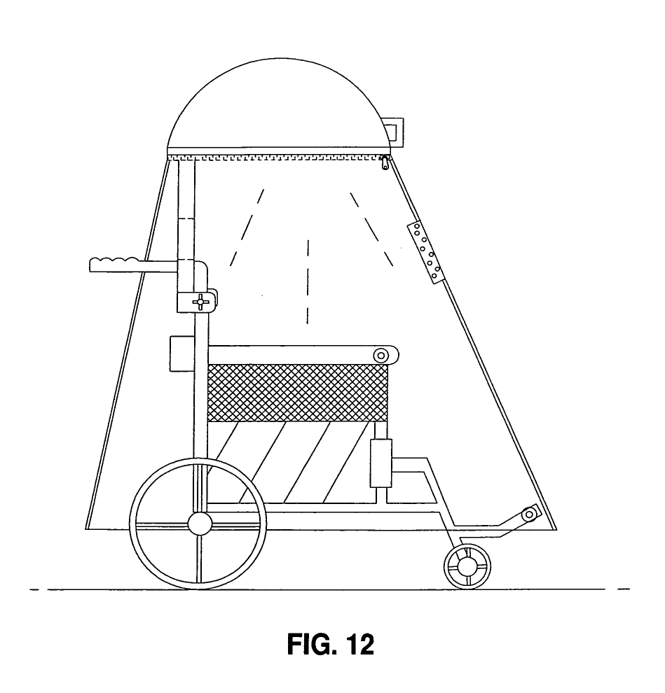

The closed plastic bubble bb is formed by the use of clear plastic strips when assembled to come together to form a bubble-like plastic bubble rain protecting the enclosure as is evident from examining FIGS. 6 and 7. The clear plastic bubble that forms the top most “roof” of the plastic bubble is configured to surround the wheelchair and any chair occupant to occupant's knees. In this configuration, the plastic bubble slides over the wheelchair handle as illustrated in FIGS. 6 and 7. These folds of clear plastic are mounted together to thereby form a bubble-like rain protector best illustrated in FIG. 7. The bottom end of the plastic bubble may be provided by an additional rain protector cover that is sized to cover the knees of a seated individual to the foot plate as best viewed from FIGS. 6 and 7. The bottom plastic cover may be constructed to be attached and secured to enclose the wheelchair by a zipper attachment as is known by those skilled in the art.

1. An improved, all weather wheelchair comprising a conventional wheelchair mounted to a frame and engaging a supporting surface to allow the wheelchair to be wheeled along the supporting surface by means of said spaced wheels when a moving force is executed against the wheelchair, a hood mounted to said frame and swing able between an upright position above an occupied chair for the shielding of an occupant of the wheelchair for protecting the chair occupant from exposure to the elements such as rain or snow or similar precipitation and including shading against the sun from a non-shielding position to an expanded, shielding position and a control arm secured to said hood for controlling the positions of the hood and operable by occupant of the wheelchair seat to position the hood between the shielding and non-shielding positions.

2. An improved all weather wheelchair configuration as defined in claim “I” wherein said shielding structure has a semi-circular configuration that when in a shielding position is spaced vertically of an individual in the wheelchair seat and rotatable through said control arm for rotating the position of the shielding structure.
